(19) United States
(12) Patent Application Publication
(10) Pub. No.: US 2015/0168148 A1
(43) Pub. Date: Jun. 18, 2015

(54) Systems and Methods for Generating Guidebook Routes

(71) Applicant: Google Inc., (US)

(72) Inventors: Lucien Pech, Zurich (CH); Albert Graells, Zurich (CH)

(73) Assignee: Google Inc., Mountain View, CA (US)

(21) Appl. No.: 13/894,002

(22) Filed: May 14, 2013

(51) Int. Cl. G01C 21/00

(52) U.S. Cl. CPC G01C 21/00

(57) ABSTRACT

Systems and methods for recommending time independent or “guidebook” transit routes between an origin and a destination are provided. Inputs of a trip pattern, an interval of times, and the timetables of the trips of the trip pattern, can result in output of a list of all considered trips (including departure time and duration thereof) and a list of lines for each transit step.

### FIELD

The present disclosure relates generally to public transportation trip planning and more particularly to generating time independent transit routes or “guidebook” transit routes between an origin and a destination for recommendation to a user.

### BACKGROUND

Many services exist for planning a route using a transit system. Typically, a user inputs a departure and/or arrival time as well as origin and destination locations to the transit planning service. The transit planning service can then use the user inputs and transit schedules to suggest one or more transit options that can get the user from the origin to the destination at the prescribed departure and/or arrival time. The transit planning services can plan transit trips involving multiple modes of transportation, including railway transportation, buses, ferries, etc.

In some situations, a user may not be interested in obtaining a transit trip for a particular departure and/or arrival time. Rather, the user is interested in time independent transit routes that represent typically good trips between the origin and destination over the course of a time interval, such as during business hours. These time independent routes or “guidebook” routes may be analogous to a typical or usual route one might take from the origin to the destination, such as a route that one might find in a guidebook or a tourist brochure.

Many different time independent transit routes may be available between the origin and the destination. Each of the time independent transit routes have a different sequence of stations at which to transfer. Computing cost for such routes requires knowledge of the trips involved for each sequence of stations.

### SUMMARY

Aspects and advantages of the invention will be set forth in part in the following description, or may be obvious from the description, or may be learned through practice of the invention.

In certain exemplary aspects of the present disclosure, systems and methods for recommending time independent transit routes between an origin and a destination are provided. Inputs of a trip pattern, an interval of times, and the timetables of the trips of the trip pattern, can result in output of a list of all considered trips (including departure time and duration thereof) and a list of lines for each transit step.

One exemplary aspect of the present disclosure is directed to a computer-implemented method for public transportation journey planning. The method includes receiving transit data corresponding to a sequence of stations and schedule information for lines at the sequence of stations. A first search of the transit data determines a first journey schedule for a route between a source station, one or more intermediate stations, and a destination station. The first journey schedule includes an earliest arrival time of a line at the destination station. A second search of the transit data determines a second journey schedule for the route. The second journey schedule includes one or more departure times of lines from the one or more intermediate stations and a latest departure time of a line from the source station that can achieve the earliest arrival time of a line at the destination station. A third search of the transit data determines a third journey schedule for the route. The third journey schedule includes one or more earliest departure times of lines from the one or more intermediate stations that can achieve the latest departure time of a line from the source station and the earliest arrival time of a line at the destination station. Each of the first search, the second search, and the third search are repeated to determine a fourth journey schedule, a fifth journey schedule, and sixth journey schedule, respectively, for a route between a source station, one or more intermediate stations, and a destination station. The fourth journey schedule includes an earliest arrival time of a line at the destination station when an earliest departure time of a line from the source station is later than the earliest departure time of a line of the third journey schedule. The fifth journey schedule includes one or more departure times of lines from the one or more intermediate stations and a latest departure time of a line from the source station that can achieve the fourth journey schedule earliest arrival time of a line at the destination station. The sixth journey schedule includes one or more earliest departure times of lines from the one or more intermediate stations that can achieve the fifth journey schedule latest departure time of a line from the source station and the forth journey schedule earliest arrival time at the destination station.

Other exemplary aspects of the present disclosure are directed to systems, apparatus, non-transitory computer-readable media, computer program products, user interfaces and devices for transit route planning.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a schematic block diagram of a route planning system according to an exemplary embodiment of the present disclosure;

FIG. 2 depicts an illustrative example of a transit graph according to an exemplary embodiment of the present disclosure;

FIG. 3 depicts a schematic flow diagram illustrating the creation of transit graph data and transfer patterns by a pre-computation module shown in FIG. 1, and also the formation of a query graph in response to a user query so as to select an optimal route according to an exemplary embodiment of the present disclosure;

FIG. 4 depicts a flow diagram illustrating the performance of the query according to an exemplary embodiment of the present disclosure;

FIG. 5 depicts an illustrative example of a line graph according to an exemplary embodiment of the present disclosure;

FIG. 6 depicts an illustrative example of a timetable according to an exemplary embodiment of the present disclosure;

FIG. 7 depicts a flowchart of an exemplary method for transit route planning according to an exemplary embodiment of the present disclosure; and

FIG. 8 depicts a block diagram of an exemplary computer-based system for transit route planning according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to generating time independent or “guidebook” transit routes between an origin and a destination. A time independent transit route is not a particular transit trip that occurs at a particular time. Rather the time independent transit route can include or be associated with a plurality of transit trips over the transit route between the origin and destination over a given time interval, such as over the course of a business day.

For instance, a time independent transit routes can take the form: “Take tram 3 or tram 4 between Station S and Station T between the hours of 8:00 a.m. and 6:00 p.m.” The time independent transit route “tram 3” can be associated with a plurality of transit trips including one for each instance of tram 3 during the time interval between 8:00 a.m. and 6:00 p.m. The time independent transit route “tram 4” can be associated with a plurality of transit trips including one for each instance of tram 4 during the time interval between 8:00 a.m. and 6:00 p.m. It can be possible that the service hours are different for tram 3 and for tram 4. For instance, tram 3 can operate from 8:00 a.m. to 5:00 p.m. and tram 4 can operate from 9:00 a.m. to 6:00 p.m. In this case, it can be desirable to recommend tram 3 during its hours of operation and tram 4 during its hours of operation.

In certain aspects of the present disclosure, inputs of a trip pattern (i.e. a sequence of stations at which transfers take place, including possibly the transfer durations, and the initial and final walking), an interval of times (during which departure times are considered), and the timetables of the trips of the trip pattern, can result in output of a list of all considered trips (including departure time and duration thereof) and a list of lines for each transit step.

To generate time independent transit routes between an origin and a destination, searches are first undertaken to identify optimal departure times from a source station and/or one or more intermediate stations while maintaining a lowest cost arrival time at a destination station. For instance, three least cost searches can be performed to identify suitable journey schedules. When a shortest path algorithm (e.g., Dijkstra's algorithm) is utilized to compute the best trip from station S (source) to station T (target), starting at t1S, the best arrival time at each possible station (such as intermediate stations A and B) can be achieved. If the optimal trip is S->A->B->T, the best possible arrival time at station A is achieved, the best possible arrival time at station B is achieved, and the best possible arrival time at station T, referred to as t1T, is achieved. Such a result is good because the search determines that it is not possible to arrive at station T earlier than t1T, but there is a possibility that there are other trips that depart later than t1S that will still allow arrival at station T at time t1T. A second search can be utilized to solve for such trips.

In order to find the latest trip departing from station A that will allow arrival at station T at time t1T, another shortest path search is utilized, but this time going “backwards” in the graph, doing the search starting at station T and traveling back in time. With this search, the latest departure time from station S that allows arrival at station T optimally at t2S can be determined. In addition, the latest possible departure time for each intermediate leg can be determined. As such, the best (latest) possible departure from station S that allows arrival at station T as early as possible can be determined A problem remains that the connections at the intermediate stations that have been determined are the last available connections allowing arrival at t1T, as there are earlier connections from A->B that are feasible and that will not change optimal times t2S and t1T. Assume that the latest possible departure from station A is t2A.

If a third search going forward in time is performed (in the manner of the first search described above), starting at station S at time t2S, the best possible arrival time at station T can be achieved, which will be t1T. In addition, the earliest possible departure at each intermediate node can be determined. For all of the intermediate steps, the second search provides the latest transit trip that can be taken that will allow arrival at time t1T at station T. The third search, departing at time t2S from station S, will provide for all of the earliest possible departure for each of intermediate steps that can be taken. So for all of the intermediate steps, all of the trips between the one returned by the third search, and the one returned by the second search, can allow the user to reach the destination.

The three searches described above are performed again as fourth, fifth, and sixth searches, with the fourth search starting at the next earliest available departure time from the source station after the departure time of the first search from the source station. For instance, the fourth search can begin at the earliest departure time after t2S, such as one second after t2S. The fifth and sixth searches are performed as described above in relation to the second and third searches. In this manner, the connections A->B that are between times t3A and t2A are good and allow destination station T to be reached as fast as possible, while departing from source node station S as late as possible. From the results, trip durations and transit lines can be stored and presented to a user as time independent transit routes.

The fourth search can start from the source station at the earliest available time after the third search started from the source station. For instance, the fourth search can begin at one second later from the source station than the third search. In other aspects of the present disclosure the fourth search can begin at a different time increment, i.e., ten second, twenty seconds, thirty seconds, or the like after the third search departure time from the source station. After the fourth search, fifth search, and sixth searches are completed, a determination can be made as to whether the departure time from the source station is greater than the end of the input interval. If the departure time is not greater than the end of the input interval, the searches are repeated (again as three searches). In this case, the departure time will be incremented again to reflect the new later departure time. If the departure time is equal to or greater than end of the input interval, all of the stored trip durations and transit lines can be presented to a user as time independent transit routes.

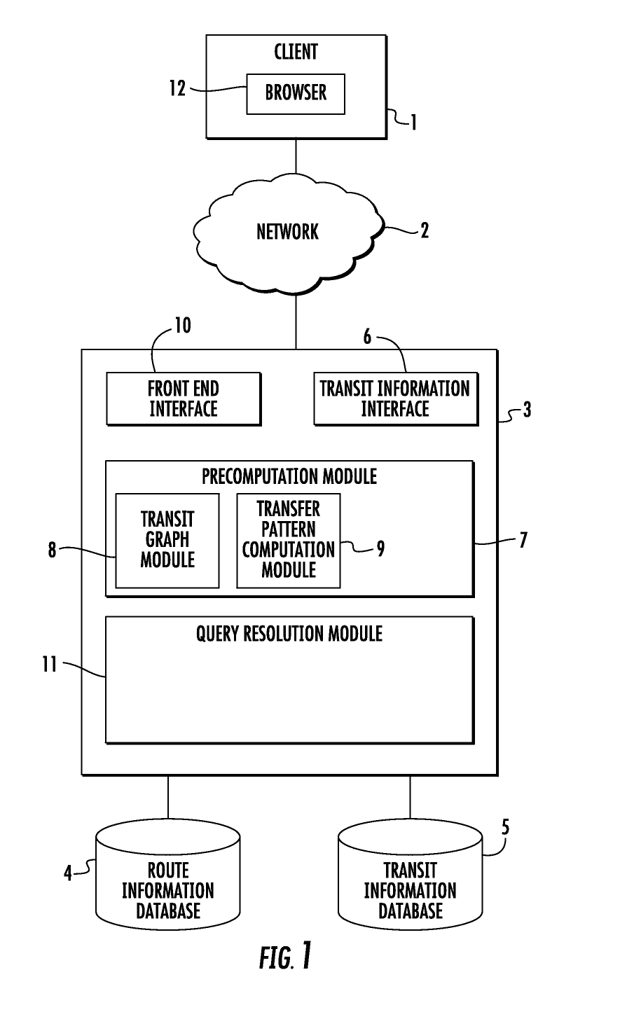

FIG. 1 is a block diagram of public transport journey solution in which a user may use a client device 1 connected through a network 2 to a transit server 3 which is provided with a route information database 4 at a transit database information 5. The network 2 may comprise any suitable network such as the Internet or other WAN, a wireless telecommunications network or a LAN, which may be wired or wireless. The client device may comprise a personal computing device, which may be portable or a mobile telecommunications device for example with Internet functionality.

The transit server 3 is configured to respond to queries from a user client 1 to provide route planning information to the user in response to a query for an optimum route between a user defined start or source destination and a user defined end destination, for example for a particular start time or arrival time.

As shown in FIG. 1, the transit server 3 comprises a number of processing modules. It will be appreciated that the term “module” refers to computer logic utilized to provide specified functionality. Thus, a module can be implemented in hardware, firmware and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM hard disk or optical or magnetic media.

Also, it will be appreciated that embodiments of the server 3 can have different or other modules to the ones described herein, with the described functionalities distributed among the modules in a different manner.

Referring to FIG. 1, the transit server 3 is configured to develop data corresponding to a transit graph. The server includes a transit information interface 6 which receives transport schedule information as published by different public transportation service providers such as rail transport systems providers, bus companies and the like. In one example, each agency providing such schedule information is in communication with the transit server 3 to provide the scheduling information in a specified format such as the Google transit feed specification (GTFS) described at http://code.google.com/transit/spec/transit_feed_specification.html. The transit information received includes public transportation schedules describing calendar dates when a public transport vehicle makes a particular trip and station information e.g. the address describing stations where stops are made along the trip. Other attributes of the trip may include the monetary cost and the times where stops are made at different stations along a particular route.

The received transit information is stored in a transit information database 5 from the different information sources. For example, the database 5 may store bus schedule information from a public bus system, train schedule information for local commuter trains, long distance trains and subway schedules for a subway system. Other scheduling information will also be evident to those skilled in the art.

The data stored in the transit information database 5 is stored in terms of a transit graph which is prepared by a pre-computation module 7, which includes a transit graph module 8 and also a transfer pattern computation module 9 to be described hereinafter.

For each arrival and/or departure of the vehicle at a station, the transit graph module 8 inserts nodes into a transit graph in which one axis represents the distance between stations and another axis represents the passage of time. Typically two nodes are inserted representing respectively an arrival event and a departure event, at the respective times of day. Thus, if a vehicle does not arrive/depart at a station, no node is created at this station since no departure or arrival event occurs at this station. Since nodes in the transit graph are generated from the specified scheduling information received by the interface 6, each node is associated with a vehicle at a station at a specific time. A node in the transit graph can be a station node or an onboard node. A station node represents a vehicle at a station that a user can board in order to make a trip. In contrast, an onboard node represents a public transit vehicle on which a user is currently boarded that is located at the station associated with the node. Nodes in the transit graph are connected to one another by arcs that describe the route of a trip. In the examples described herein, there are four types of arcs: boarding arcs describing a vehicle being boarded at a station, boarding or alighting arcs describing a vehicle being exited at a station with optional walking if a person should walk to another station to board a transit vehicle to complete a journey, waiting arcs describing a person waiting at a transit station, and transit arcs describing staying onboard a vehicle between two stops of a trip.

As mentioned above, the transit graph module 8 analyzes the schedule information received through the interface 6 to determine the events taking place at individual stations. Based on the event, the transit graph module 8 places a corresponding node (either station or onboard) in the transit graph and connects the nodes with arcs. The type of arc connecting two nodes is based upon whether the nodes being connected are station or onboard nodes. For example, if the transit information describes that a vehicle is boarded at station A and travels to station B without a transfer, the transit graph module 8 includes a station node associated with station A in the transit graph and includes an onboard node associated with station B in the transit graph. Thus, the arc connecting the nodes is a boarding arc. In another example, if an onboard node is connected to a station node, the arc connecting the nodes is a boarding arc.

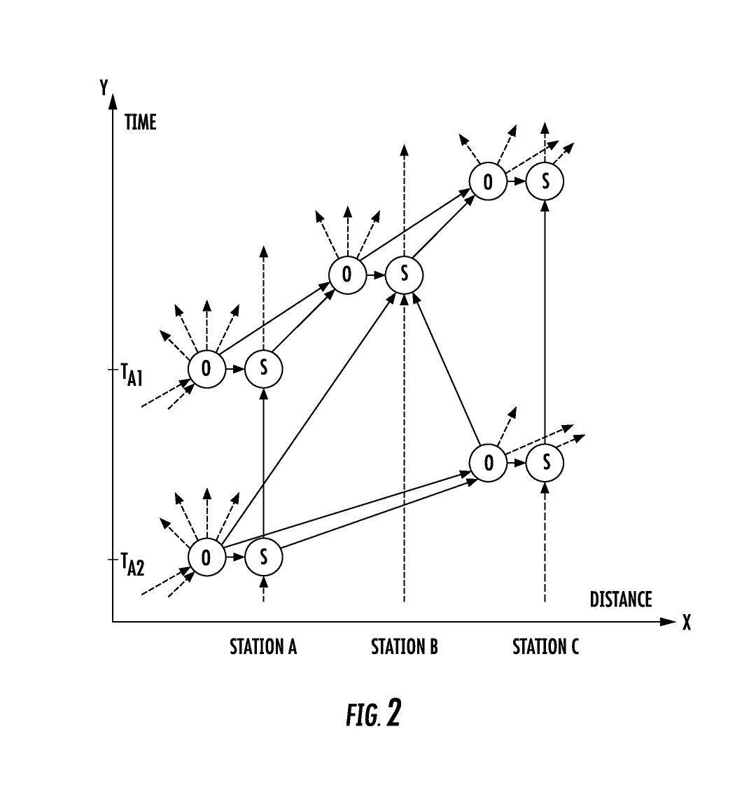

One example of a portion of a transit graph is illustrated in FIG. 2. The Y-axis of the transit graph represents time and the X-axis represents stations A, B, C . . . . It will be appreciated that the X and Y axes here are illustrated as a convenient way to explain the use of the transit graph data, and in actual practice the transit graph data stored in the database 5 does not include an X or Y axis, nor are the nodes of the graph arranged in a spatial manner as shown in FIG. 2.

In this illustration, the Y-axis is a time representation of a single day and for each station S represented on the X-axis, the transit graph module 8 adds a series of nodes to the transit graph, which are arrayed along the Y-axis. Each node in the series associated with a station represents a transit event that occurs at the station at the particular time associated with the node.

As shown in the transit graph, stations A, B, C . . . each include a series of nodes at different time intervals. Nodes labeled with an “S” are station nodes and nodes labeled with an “O” are onboard nodes as previously discussed. Each station node associated with the given station is associated with some event occurring at the station at a particular time. The station nodes S for station A are shown sequentially connected in time, to represent that a person can wait at station A for time period between TA1 and TA2.

Typically, the transit graph data created and stored in the transit information database 5 can comprise arcs for a very large number of nodes, for example for stations distributed over an entire continent or a geographical region e.g. North America or Europe and although a route planning query can be made in respect of the transit graph data, a significant processing time may be involved. To overcome this difficulty, the pre-computation module 7 illustrated in FIG. 1 includes the transfer pattern computation module 9 which is operable to define and pre-compute feasible routes between stations for which the nodes have been stored in a transit information database 5 i.e. pre-computed before a route planning query is carried out.

The feasible routes are computed by performing a search between nodes and along arcs for start and destination stations for a particular journey, by seeking the least cost route along the arcs defined in the transit data database 5 between the nodes. The search may be performed with a suitable search algorithm such as the Dijkstra search algorithm.

Each node may be tagged with a multi-dimensional cost parameter label for items such as journey duration walking between nodes etc. so that a path of least cost can be computed between the start or source node and the destination node. For a particular source and destination node, the optimal transfer patterns between them are computed over a particular time range e.g. 1 day, 1 week or the like and the resulting transfer patterns are stored in the route information database shown in FIG. 1.

The pre-computation of the transfer patterns is performed for at least the major set of pre-defined start-destination pairs of nodes stored in the transit information database 5.

The pre-computation process is illustrated schematically in FIG. 3. At step S3.1, the transit graph module 8 of the pre-computation module 7 computes the transit graph data, which is stored in the transit information database 5 shown in FIG. 1.

At step S3.2, the transfer pattern computation module 9 computes the transfer patterns over a given time period between a plurality of different start and destination nodes as described above and stores the resulting transfer pattern data in the route information database 4.

When a user wishes to plan a journey using the system, they may utilize client 1 to send a query through network 2 to a front end interface 10 which supplies the query to a query resolution module 11 which interrogates the transfer pattern data stored in the route information database 4 as will be described in more detail herein.

The user may use browser 12 running on client 1 to define a source location at which the journey is to commence along with the destination station and a start time of day for the journey or a range of times during the day to commence the journey. For simplicity in this example the source location is a station which is referred to herein as the source station but it will be appreciated that the source location can be any other suitable map location. This information is communicated to the query resolution module 11, which then builds a query graph from the transfer patterns stored in database 4 in respect of the user defined source and destination stations. This is illustrated at step S3.3 in FIG. 3.

The query is then run on the data of the query graph at step S3.4 in order to select one or more trip patterns, or sequences of stations, between the source and destination stations.

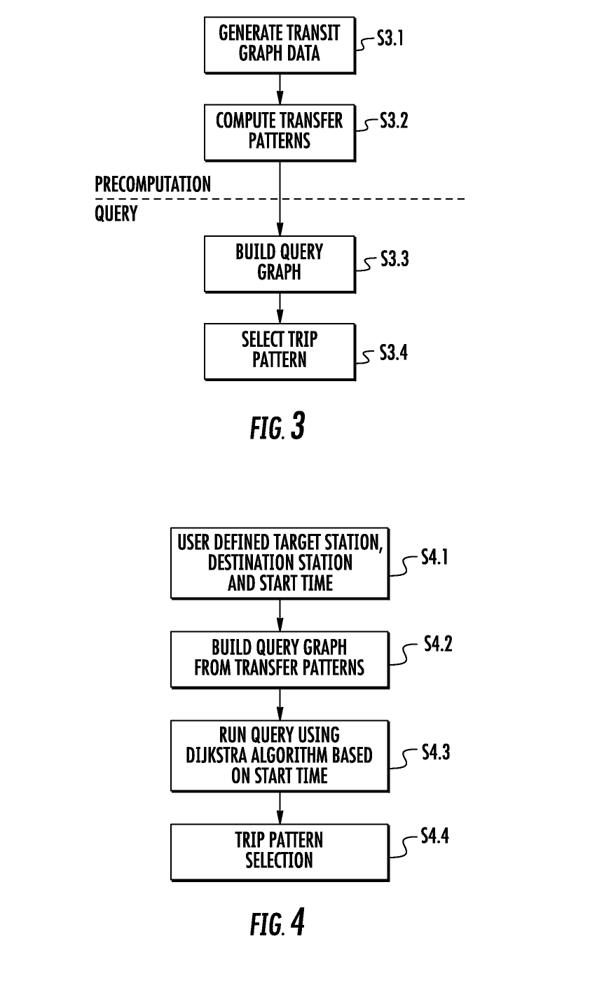

Referring to FIG. 4, in step S4.1, the user utilizes browser 12 of client 1 (as illustrated in FIG. 1) to define a query that includes a source station, destination station and a start time for the journey, or a range of start times. Alternatively, an arrival time or range of arrival times may be defined. The query is transmitted to the query resolution module 11 as shown in FIG. 1, which builds a query graph from the transfer patterns as illustrated in step S4.2.

From the foregoing, it will be appreciated that the query graph that is specific to the defined start and destination stations at the defined time may include a number of feasible routes defined by the arcs extending between candidate nodes situated between the source and destination nodes.

At step S4.3, the query resolution module 11 runs a query using a suitable search algorithm, based on the defined start time to identify one or more routes of least cost, so as to select one or more trip patterns as illustrated at step S4.4. Any suitable search algorithm may be used and by way of illustrative example, the use of a Dijkstra algorithm will be described hereinafter, although other algorithms of similar functionality will be evident to those skilled in the art.

In accordance with the present disclosure, the trip patterns, schedule information, and an interval of times, as previously described above, can be utilized as inputs to generate outputs of departure time, duration, and lines considered for such trip patterns.

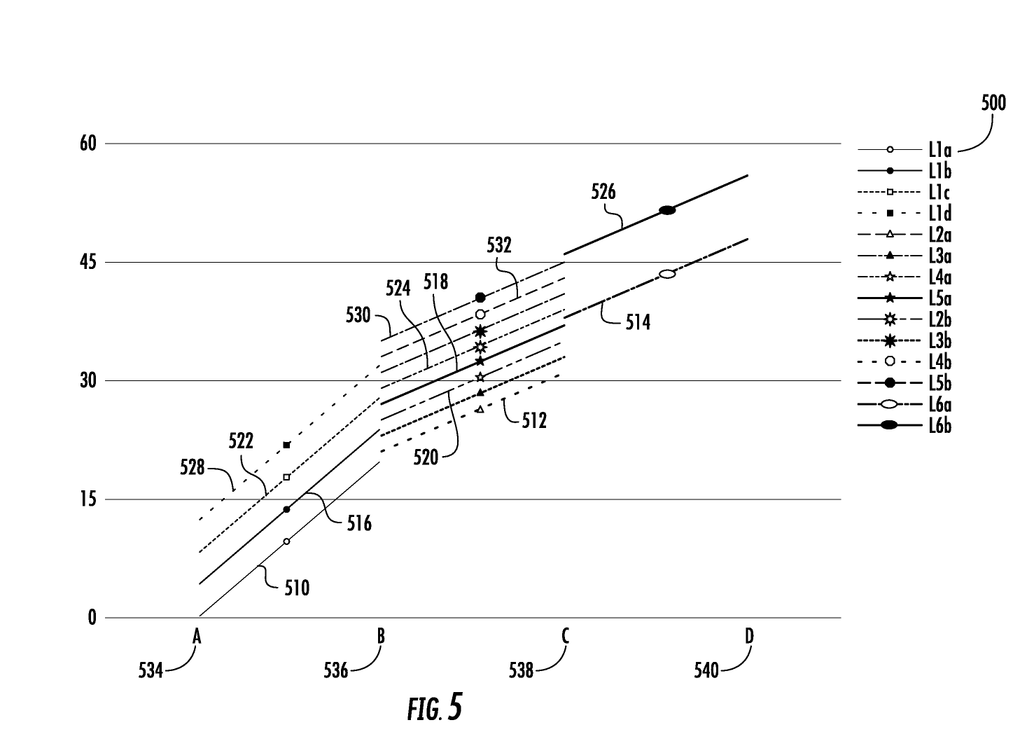

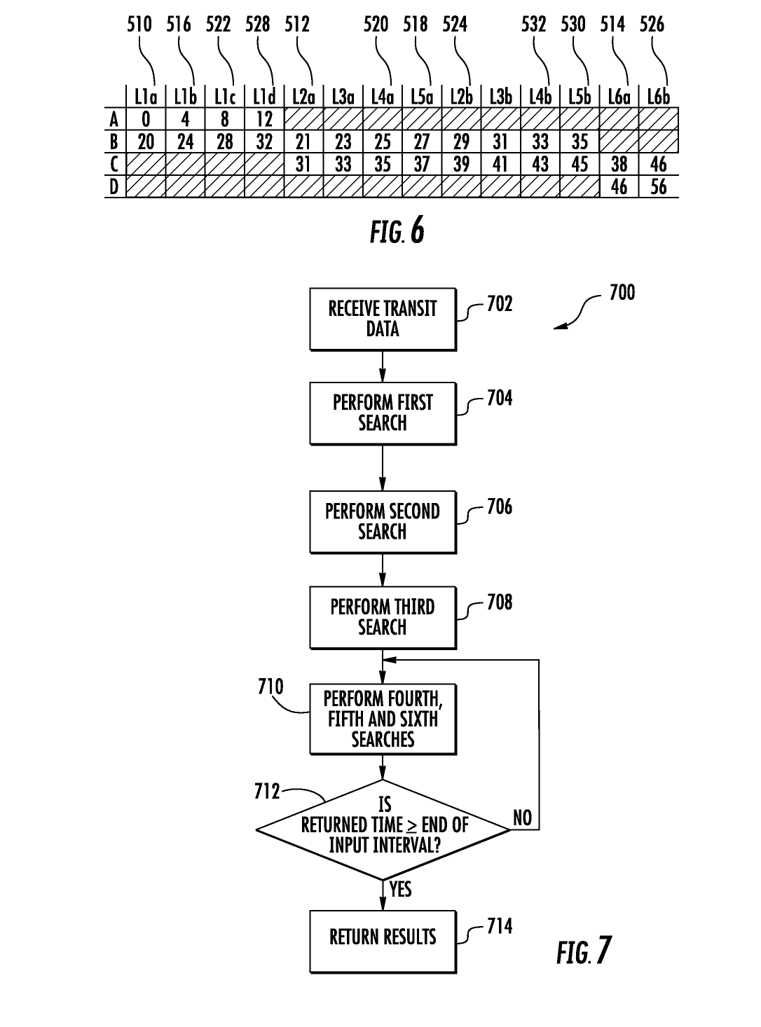

Reference is now made to FIGS. 5 and 6, in which an exemplary line graph (500) and timetable, respectively, will be described. As illustrated, the line graph illustrates trips in which a user departs from station A (534), takes a transit trip from station A (534) to station B (536), transfers at station B (536), takes a transit trip from station B (536) to station C (538), transfers at station C (538), and takes a transit trip from station C (538) to station D (540). Transit journeys traveling from station A to station B, transferring at station B, traveling from B to C, transferring at C, and finally traveling from C to D, are presented.

The following trips run: Line 1: a semi-frequent commuter train that runs between A and B, takes 20 minutes to go from A to B, runs every 4 minutes starting from the hour; Line 2, 3, 4, and 5 are frequent buses that take 10 minutes to go from B to C, run every 8 minutes (Line 2 runs first at 21, line 3 at 23, line 4 at 25, line 5 at 27); Line 6 is a train that runs from C to D every 8 minutes, and takes 10 minutes, starting from 38.

Trips departing between 0 and 12 inclusive are reviewed. Three searches departing from 0, as described herein, are performed. A least cost search as described herein considers 1) transit trips departing from station A (534) after time T, that arrive the earliest at station B (536) (at time TB), 2) transit trips departing from station B (536) after time T, that arrive the earliest at station C (538) (at time TC), 3) transit trips departing from station C (536) after time T, that arrive the earliest at station D (540) (at time TD). A first forward search returns L1a (510), L2a (512), L6a (514). An earliest arrival time of 48 is determined.

Thus, TD is the earliest possible arrival time at station D (540), given the departure time T at station A (534). However, the sequence of three trips returned by this least cost search can be bad for the user. As an example, if T is in the evening, the user could be required to spend the whole night at station B or station C. By contrast, if the user departs from station A the following morning, the user might still arrive at TD.

So to find the latest departure time that allows the user to arrive at time TD, a second least cost search as described herein can be performed in the reversed graph. Departing from station D (540) the search considers 1) transit trips arriving at station D (540) at time TD, that depart the latest from station C (538) at time TC2, 2) transit trips arriving at station C (538) before time TC2, that depart the latest from station B (536) at time TB2, 3) transit trips arriving at station B (536) before time TB2, that depart the latest from station A (534) at time TA2. Backward search returns L1b (516), L5a (518), L6a (514). A latest departure time of 4 is determined.

Therefore, TA2 is the latest time at which a trip departs from station A (534), and arrives at time TD at station D (540). But this sequence of trips may still be bad for the user. Indeed, at any intermediate step, the sequence provides the latest possible vehicle, even though an earlier vehicle is present. From a user perspective, taking the earliest possible vehicle at each step is often preferable.

As such, a third least cost search can be performed departing from station A (534), at time TA2. This search is similar to the first search, and will arrive at the same time TD (but the intermediate steps may differ). The third (forward) search returns L1b (516), L4a (520), L6a (514).

The first output trip has departure time 4 and duration 44. For the step A->B, line 1 is added as a line to consider. For the step B->C, line 4 and line 5 are added as lines to consider (any line departing after 25 and before 27 would also be added). For step C->D, line 6 is added as a step to consider. The optimal trip is 516->{all the connections between 518 and 520 inclusive}->514. In this manner, the three search process described herein can identify optimal departure times from a source station and/or one or more intermediate stations while maintaining a lowest cost arrival time at a destination station.

Next, another three searches are completed departing after the previous trip departed from the source station as determined by the second and third searches (at 4:01 for example) which returns L1c (522), L2b (524), L6b (526) as the fourth search. Backward search (fifth search) returns L1d (528), L5b (530), L6b (526). The third (forward) search (sixth search) returns L1d (528), L4b (532), L6b (526). The departure time is 12, the travel time is 44. The lines are the same as previously determined.

So in the present example, the following are returned: trips (departure time, duration) [(4, 44), (12, 44)] and lines for each step: [{line 1}, {line 4, line 5}, {line 6}]. As described previously, the fourth search starts from the source station at the earliest time after the third search started from the source station. For instance, the fourth search can begin at one second later from the source station than the third search. After the fourth, fifth, and sixth searches, a determination can be made as to whether the departure time from the source station is greater than the end of the input interval. If the departure time is not greater than the end of the input interval, the searches are repeated (again as three searches). In this case, the departure time will be incremented again to reflect the new later departure time. If the departure time is equal to or greater than end of the input interval, some or all of the returned trip durations and transit lines can be presented to a user as time independent transit routes.

The resulting data is then transmitted by the server 3 through the front end interface 10 and network 2 to the client 1 so as to be presented on browser 12 to the user. The route/schedule is displayed in terms of the stations to be utilized for the selected route, along with details of any transfers or transit required between different train or bus lines and the associated times.

FIG. 7 depicts a flow diagram of an exemplary method (700) for public transportation journey planning according to an exemplary embodiment of the present disclosure. While exemplary method (700) will be discussed with reference to the system of FIG. 1, method (700) can be implemented using any suitable computing system. In addition, although FIG. 5 depicts steps performed in a particular order for purposes of illustration and discussion, methods of the present disclosure are not limited to such particular order or arrangement. One skilled in the art, using the disclosures provided herein, will appreciate that various steps of the method (700) can be omitted, rearranged, combined, and/or adapted in various ways without deviating from the scope of the present disclosure.

At (702) transit data describing a sequence of station and scheduling information is received in response to a user query of an interval of departure times from a source station to a destination station (e.g., 8:00 am through 8:00 pm on a given day). As an example, transit data can be received by transit information database 5.

At (704) a first search of the transit data is performed to determine a first journey schedule for a route between a source station and a destination station. The first journey schedule includes a first departure time from the source station, a first arrival time at the destination station, and one or more first intermediate departure times from one or more intermediate stations.

At (706) a second search of the transit data is performed to determine a second journey schedule for the route between the source station and the destination station. The second journey schedule includes the first arrival time at the destination station, a second departure time from the source station (d1), and one or more second intermediate departure times from the one or more intermediate stations. The second departure time (d1) and the one or more second intermediate departure times are latest times available to achieve the first arrival time.

At (708) a third search of the transit data is performed to determine a third journey schedule for the route between the source station and the destination station. The third journey schedule includes the second departure time from the source station, the first arrival time at the destination station, and one or more third intermediate departure times from the one or more intermediate stations. The one or more third intermediate departure times are earliest available times to maintain the second departure time (d1) and the first arrival time.

At (710) the first, second, and third searches are completed again to yield a fourth journey schedule, fifth journey schedule, and sixth journey schedule. The fourth journey schedule departs from the source station at the earliest time after the previous trip departed from the source station (d1) as determined by the second and third searches and reflected in second and third journey schedules. For instance, the new departure time can be d1+1 which provides a new departure time of d2. At (712), a determination is made as to whether the returned time d is greater than the end of the input interval (e.g., 8:00 pm). If the returned time d is not greater than end of the input interval, the searches at (710) are repeated (again as three searches). In this case, d will be incremented again to d3 to reflect the new later departure time. If the returned time d is equal to or greater than end of the input interval, the method moves to (714).

At (714), trips, including departure time and duration, and lines for each step are returned. In this regard, departure time and duration (duration can be calculated based on the departure time from the source station and the arrival time at the destination station) are determined from the third journey schedule and sixth journey schedule. Lines for each step are determined from the third journey schedule and sixth journey schedule by considering the lines that make up the respective journey schedules. In addition, intermediate lines from the second and fifth journey schedules can be considered, as can any lines having departure times that fall between the departure times of intermediate line(s) of the second and third journey schedules and the fifth and sixth journey schedules. In this manner, a variety of suitable lines can be presented for a user's consideration. While specific departure times, durations, and lines are described, it should be understood that other departure times, durations, and lines that are determined through one or more of the searches performed can be presented in addition to or instead of those described above. For instance, subsets of the information described above can be returned, such as only certain lines or only certain departure times and/or durations.

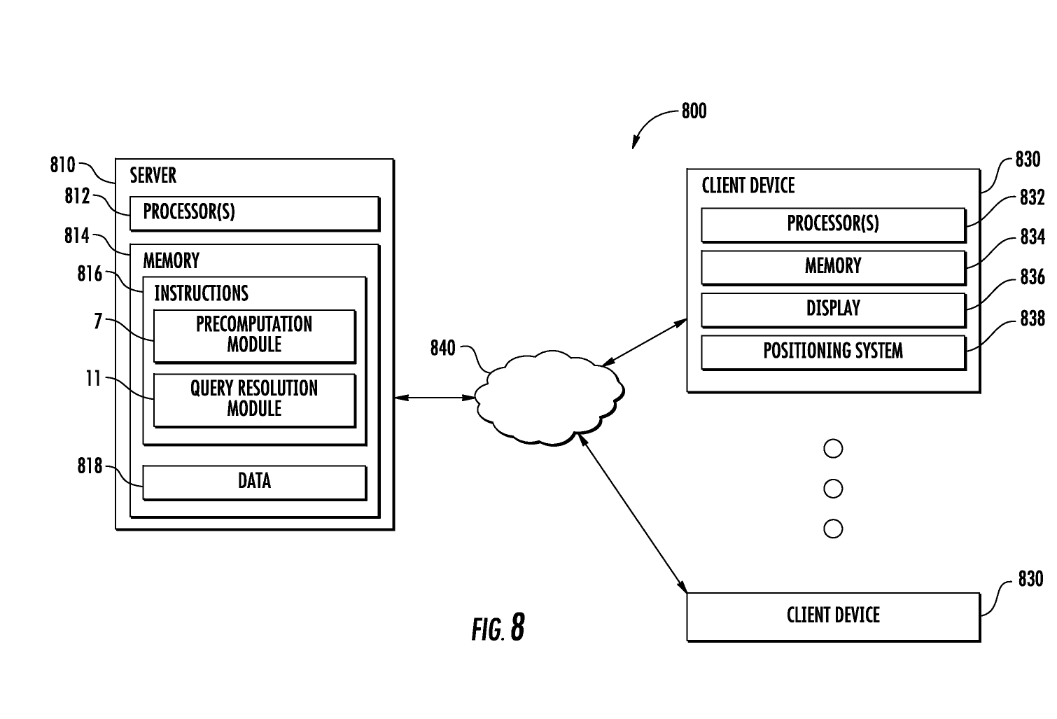

FIG. 8 depicts an exemplary computing system 800 that can be used to implement the methods and systems for transit routing planning according to aspects of the present disclosure. The system 800 is a client-server architecture that includes a server 810 that communicates with one or more client devices 830 over a network 850. The system 800 can be implemented using other suitable architectures, such as a single computing device.

The system 800 includes a server 810, such as a web server. The server can be implemented using any suitable computing device(s). The server 810 can have a processor(s) 812 and a memory 814. The server 810 can also include a network interface used to communicate with one or more remote computing devices (e.g. client devices) 930 over a network 840.

The processor(s) 812 can be any suitable processing device, such as a microprocessor, microcontroller, integrated circuit, or other suitable processing device. The memory 814 can include any suitable computer-readable medium or media, including, but not limited to, non-transitory computer-readable media, RAM, ROM, hard drives, flash drives, or other memory devices. The memory 814 can store information accessible by processor(s) 812, including instructions 816 that can be executed by processor(s) 812. The instructions 816 can be any set of instructions that when executed by the processor(s) 812, cause the processor(s) 812 to provide desired functionality. For instance, the instructions 816 can be executed by the processor(s) 812 to implement the precomputation module 7, and the query resolution module 11.

Memory 814 can also include data 818, such as transit graphs generated for time transit routes, that can be retrieved, manipulated, created, or stored by processor(s) 812. The data 822 can be stored in one or more databases. The one or more databases can be connected to the server 810 by a high bandwidth LAN or WAN, or can also be connected to server 810 through network 840. The one or more databases can be split up so that they are located in multiple locales.

The server 810 can exchange data with one or more client devices 830 over the network 840. Although two clients 830 are illustrated in FIG. 8, any number of client devices 830 can be connected to the server 810 over the network 840. As described previously, the client devices 830 can be any suitable type of computing device, such as a general purpose computer, special purpose computer, laptop, desktop, integrated circuit, mobile device, smartphone, tablet, or other suitable computing device.

Similarly the computing device 810, a client device 830 can include a processor(s) 832 and a memory 834. The memory 834 can store information accessible by processor(s) 832, including instructions that can be executed by processor(s) and data. The client device 830 can include various input/output devices for providing and receiving information from a user, such as a touch screen, touch pad, data entry keys, speakers, and/or a microphone suitable for voice recognition. For instance, the computing device 830 can have a display 836 for presenting information, such as recommended transit routes to a user.

The client device 830 can also include a positioning system 838 that can be used to identify the position of the client device 830. The positioning system 838 can be optionally used by the user to monitor the user's position relative to a transit route. The positioning system 838 can be any device or circuitry for monitoring the position of the client device 830. For example, the positioning device 838 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

In situations in which the systems and method discussed herein collect information about users, such as position data, user preferences, or other information, the users may be provided with an opportunity to control whether programs or features collect the information and control whether and/or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in or more ways before it is stored or used, so that personally identifiable information is removed.

The network 840 can be any type of communications network, such as a local area network (e.g. intranet), wide area network (e.g. Internet), or some combination thereof. The network 840 can also include a direct connection between a client device 830 and the server 810. In general, communication between the server 810 and a client device 830 can be carried via network interface using any type of wired and/or wireless connection, using a variety of communication protocols (e.g. TCP/IP, HTTP), encodings or formats (e.g. HTML, XML), and/or protection schemes (e.g. VPN, secure HTTP, SSL).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for public transportation journey planning, the method comprising:
receiving transit data corresponding to a sequence of stations and schedule information for lines at the sequence of stations;
a first search of the transit data to determine a first journey schedule for a route between a source station, one or more intermediate stations, and a destination station, the first journey schedule comprising an earliest arrival time of a line at the destination station;
a second search of the transit data to determine a second journey schedule for the route, the second journey schedule comprising one or more departure times of lines from the one or more intermediate stations and a latest departure time of a line from the source station that can achieve the earliest arrival time of a line at the destination station;
a third search of the transit data to determine a third journey schedule for the route, the third journey schedule comprising one or more earliest departure times of lines from the one or more intermediate stations that can achieve the latest departure time of a line from the source station and the earliest arrival time of a line at the destination station; and
repeating each of the first search, the second search, and the third search to determine a fourth journey schedule, a fifth journey schedule, and sixth journey schedule, respectively, for a route between a source station, one or more intermediate stations, and a destination station, wherein the fourth journey schedule comprises an earliest arrival time of a line at the destination station when an earliest departure time of a line from the source station is later than the earliest departure time of a line of the third journey schedule, wherein the fifth journey schedule comprises one or more departure times of lines from the one or more intermediate stations and a latest departure time of a line from the source station that can achieve the fourth journey schedule earliest arrival time of a line at the destination station, wherein the sixth journey schedule comprises one or more earliest departure times of lines from the one or more intermediate stations that can achieve the fifth journey schedule latest departure time of a line from the source station and the forth journey schedule earliest arrival time at the destination station.

2. The computer-implemented method of claim 1, further comprising determining a duration for the third journey schedule.

3. The computer-implemented method of claim 1, further comprising determining a duration for the sixth journey schedule.

4. The computer-implemented method of claim 1, further comprising identifying lines for consideration by a user, wherein the identified lines comprise all of the third journey schedule lines, all of the sixth journey schedule lines, the one or more intermediate journey schedule lines of the second and fifth journey schedules, respectively, any additional lines having a departure time after the third journey schedule one or more earliest departure times of lines from the one or more intermediate stations but before second journey schedule one or more departure times of lines from the one or more intermediate stations, any additional lines having a departure time after the sixth journey schedule one or more earliest departure times of lines from the one or more intermediate stations but before fifth journey schedule one or more departure times of lines from the one or more intermediate stations, or combinations thereof.

5. The computer-implemented method of claim 1, further comprising identifying lines for consideration by a user, wherein the identified lines comprise all of the third journey schedule lines, all of the sixth journey schedule lines, the one or more intermediate journey schedule lines of the second and fifth journey schedules, respectively, any additional lines having a departure time after the third journey schedule one or more earliest departure times of lines from the one or more intermediate stations but before second journey schedule one or more departure times of lines from the one or more intermediate stations, and any additional lines having a departure time after the sixth journey schedule one or more earliest departure times of lines from the one or more intermediate stations but before fifth journey schedule one or more departure times of lines from the one or more intermediate stations.

6. The computer-implemented method of claim 1, wherein the first search, the second search, the third search, the fourth search, the fifth search, and the sixth search of the transit data each comprise a least cost search process.

7. The computer-implemented method of claim 6, wherein the least cost search process comprises a Dijkstra algorithm.

8. The computer-implemented method of claim 1, wherein the method further comprises receiving a user input of an interval of times for departure, the subsequently received transit data corresponding to the interval of times for departure.

9. The computer-implemented method of claim 8, wherein the method further comprises:
determining if the fifth journey schedule latest departure time of a line from the source station is less than a latest time of the interval of times of times for departure; and
repeating each of the first search, the second search, and the third search to determine three new journey schedules.

10. The computer-implemented method of claim 1, wherein the method further comprises:
determining a duration for the third journey schedule;
determining a duration for the sixth journey schedule; and
presenting to a user the third journey schedule duration, the sixth journey schedule duration, the third journey schedule latest departure time of a line from the source station, the sixth journey schedule latest departure time of a line from the source station, all of the third journey schedule lines, all of the sixth journey schedule lines, the one or more intermediate journey schedule lines of the second and fifth journey schedules, respectively, any additional lines having a departure time after the third journey schedule one or more earliest departure times of lines from the one or more intermediate stations but before second journey schedule one or more departure times of lines from the one or more intermediate stations, and any additional lines having a departure time after the sixth journey schedule one or more earliest departure times of lines from the one or more intermediate stations but before fifth journey schedule one or more departure times of lines from the one or more intermediate stations.

11. The computer-implemented method of claim 1, wherein the method further comprises:
determining a duration for the third journey schedule;
determining a duration for the sixth journey schedule; and
presenting to a user one or more of the third journey schedule duration, the sixth journey schedule duration, the third journey schedule latest departure time of a line from the source station, the sixth journey schedule latest departure time of a line from the source station, the third journey schedule latest departure time of a line from the source station, the sixth journey schedule latest departure time of a line from the source station, all of the third journey schedule lines, all of the sixth journey schedule lines, the one or more intermediate journey schedule lines of the second and fifth journey schedules, respectively, any additional lines having a departure time after the third journey schedule one or more earliest departure times of lines from the one or more intermediate stations but before second journey schedule one or more departure times of lines from the one or more intermediate stations, and any additional lines having a departure time after the sixth journey schedule one or more earliest departure times of lines from the one or more intermediate stations but before fifth journey schedule one or more departure times of lines from the one or more intermediate stations.

12. A computing system for public transportation journey planning comprising:
a memory configured to store transit data corresponding to a sequence of stations and schedule information for lines at the sequence of stations;
a processor configured to determine a first journey schedule for a route between a source station, one or more intermediate stations, and a destination station from a first search of the transit data, the first journey schedule comprising an earliest arrival time of a line at the destination station;
the processor configured to determine a second journey schedule for the route from a second search of the transit data, the second journey schedule comprising one or more departure times of lines from the one or more intermediate stations and a latest departure time of a line from the source station that can achieve the earliest arrival time of a line at the destination station;
the processor configured to determine a third journey schedule for the route from a third search of the transit data, the third journey schedule comprising one or more earliest departure times of lines from the one or more intermediate stations that can achieve the latest departure time of a line from the source station and the earliest arrival time of a line at the destination station; and
the processor configured to repeat each of the first search, the second search, and the third search to determine a fourth journey schedule, a fifth journey schedule, and sixth journey schedule, respectively, for a route between a source station, one or more intermediate stations, and a destination station, wherein the fourth journey schedule comprises an earliest arrival time of a line at the destination station when an earliest departure time of a line from the source station is later than the earliest departure time of a line of the third journey schedule, wherein the fifth journey schedule comprises one or more departure times of lines from the one or more intermediate stations and a latest departure time of a line from the source station that can achieve the fourth journey schedule earliest arrival time of a line at the destination station, wherein the sixth journey schedule comprises one or more earliest departure times of lines from the one or more intermediate stations that can achieve the fifth journey schedule latest departure time of a line from the source station and the forth journey schedule earliest arrival time at the destination station.

11. The computing system of claim 10, wherein the first search, the second search, the third search, the fourth search, the fifth search, and the sixth search of the transit data each comprise a least cost search process.

12. The computing system of claim 11, wherein the least cost search process utilized by the processor comprises a Dijkstra algorithm.

13. The computing system of claim 10, further comprising a second processor, the second processor configured to pre-compute the scheduling information.

14. The computing system of claim 10, wherein the system further comprises an interface for receiving a request for routes between the source station and the destination station.

15. A computing system of claim 14, wherein the processor is configured to present a third journey schedule duration, a sixth journey schedule duration, the third journey schedule latest departure time of a line from the source station, the sixth journey schedule latest departure time of a line from the source station, all of the third journey schedule lines, all of the sixth journey schedule lines, the one or more intermediate journey schedule lines of the second and fifth journey schedules, respectively, any additional lines having a departure time after the third journey schedule one or more earliest departure times of lines from the one or more intermediate stations but before second journey schedule one or more departure times of lines from the one or more intermediate stations, and any additional lines having a departure time after the sixth journey schedule one or more earliest departure times of lines from the one or more intermediate stations but before fifth journey schedule one or more departure times of lines from the one or more intermediate stations through the interface.

16. A computing system of claim 14, wherein the memory is configured to store a third journey schedule duration, a sixth journey schedule duration, the third journey schedule latest departure time of a line from the source station, the sixth journey schedule latest departure time of a line from the source station, all of the third journey schedule lines, all of the sixth journey schedule lines, the one or more intermediate journey schedule lines of the second and fifth journey schedules, respectively, any additional lines having a departure time after the third journey schedule one or more earliest departure times of lines from the one or more intermediate stations but before second journey schedule one or more departure times of lines from the one or more intermediate stations, any additional lines having a departure time after the sixth journey schedule one or more earliest departure times of lines from the one or more intermediate stations but before fifth journey schedule one or more departure times of lines from the one or more intermediate stations through the interface, or combinations thereof.

17. A computing system of claim 14, wherein the memory is configured to store a third journey schedule duration, a sixth journey schedule duration, the third journey schedule latest departure time of a line from the source station, the sixth journey schedule latest departure time of a line from the source station, all of the third journey schedule lines, all of the sixth journey schedule lines, the one or more intermediate journey schedule lines of the second and fifth journey schedules, respectively, any additional lines having a departure time after the third journey schedule one or more earliest departure times of lines from the one or more intermediate stations but before second journey schedule one or more departure times of lines from the one or more intermediate stations, and any additional lines having a departure time after the sixth journey schedule one or more earliest departure times of lines from the one or more intermediate stations but before fifth journey schedule one or more departure times of lines from the one or more intermediate stations through the interface.

18. A computer-program product comprising a non-transitory computer readable storage medium storing computer-readable instructions for transit route planning, the instructions when executed by a processor, cause the processor to perform operations, the operations comprising:
a first search of transit data to determine a first journey schedule for a route between a source station, one or more intermediate stations, and a destination station, the first journey schedule comprising an earliest arrival time of a line at the destination station;
a second search of the transit data to determine a second journey schedule for the route, the second journey schedule comprising one or more departure times of lines from the one or more intermediate stations and a latest departure time of a line from the source station that can achieve the earliest arrival time of a line at the destination station;
a third search of the transit data to determine a third journey schedule for the route, the third journey schedule comprising one or more earliest departure times of lines from the one or more intermediate stations that can achieve the latest departure time of a line from the source station and the earliest arrival time of a line at the destination station; and
repeating each of the first search, the second search, and the third search to determine a fourth journey schedule, a fifth journey schedule, and sixth journey schedule, respectively, for a route between a source station, one or more intermediate stations, and a destination station, wherein the fourth journey schedule comprises an earliest arrival time of a line at the destination station when an earliest departure time of a line from the source station is later than the earliest departure time of a line of the third journey schedule, wherein the fifth journey schedule comprises one or more departure times of lines from the one or more intermediate stations and a latest departure time of a line from the source station that can achieve the fourth journey schedule earliest arrival time of a line at the destination station, wherein the sixth journey schedule comprises one or more earliest departure times of lines from the one or more intermediate stations that can achieve the fifth journey schedule latest departure time of a line from the source station and the forth journey schedule earliest arrival time at the destination station.

19. The computer-program product of claim 18, wherein the first journey schedule, second journey schedule, third journey, fourth journey schedule, fifth journey schedule, and sixth journey schedule are determined using a least cost search process.

20. The computer-program product of claim 19, wherein the least cost search process comprises a Dijkstra algorithm.
